(19) United States
(12) Patent Application Publication
(10) Pub. No.: US 2021/0178545 A1
(43) Pub. Date: Jun. 17, 2021

(54) INTELLIGENT TUNGSTEN CARBIDE CUTTER

(71) Applicant: Chia-Liang Tseng, Taichung City (TW)

(72) Inventor: Chia-Liang Tseng, Taichung City (TW)

(21) Appl. No.: 16/712,868

(22) Filed: Dec. 12, 2019

(51) Int. Cl. B23Q 17/09; B23C 5/10; B23C 9/00

(52) U.S. Cl. CPC B23Q 17/0971; B23Q 17/0985; B23Q 17/098; B23C 5/10; H04W 4/38; B23C 2222/84; B23C 2240/16; B23C 2260/76; B23C 9/00

(57) ABSTRACT

An intelligent tungsten carbide cutter may include a shank, at least a cutting portion, and a sensor. The shank made of tungsten steel comprises a first end, a second end, and at least a first connecting portion, and the first connecting portion is located adjacent to the second end of the shank. The shank and the cutting portion are thermally connected through high frequency oscillation heating method, and the cutting portion is secured on the first connecting portion of the shank. An accommodating channel axially penetrates through a center portion of the first end of the shank and extends toward the second end, and the sensor is installed in the accommodating channel so as to be positioned close to the cutting portion, thereby achieving the direct and accurate sensing.

### FIELD OF THE INVENTION

The present invention relates to a tungsten carbide cutter and more particularly to a tungsten carbide cutter that has intelligent sensing function and enables its shank to be easily recycled.

### BACKGROUND OF THE INVENTION

Tungsten steel is a carbide alloy consisting of at least one metallic carbide. Tungsten steel is known as a favorable material for cutter because of its excellent properties such as high hardness, wear-resistance, toughness, heat-resistance, and corrosion-resistance. Tungsten steel tool can be used to cut not only cast iron, plastic material, chemical fiber, graphite, glass, stone, plain steel but also the materials which are difficult to process such as heat-resistant steel, stainless steel, high-manganese steel, and tool steel. Moreover, since tungsten steel is not easy to obtain, the price of tungsten steel tool is significantly higher than the general steel tool.

The common tungsten steel knife in the market is made integrally comprising a shank and a cutting portion, and when in use, the shank is held by an operator, and either the tungsten steel knife or the object to be cut is rotated, so that the cutting portion of the tungsten steel knife can cut on the surface of the object.

However, the conventional carbide cutter has following disadvantages: (i) when the cutting portion of the tungsten steel knife is worn or damaged, the shank needs to be replaced together, which is wasteful; (ii) it is difficult or too expensive to cut the tungsten steel directly, which is high cost to replace the damaged cutting portion; (iii) when to replace the tungsten steel knife is determined by an operator, and it cannot be very accurate due to different processing conditions, which may lead to waste and inconvenience. Therefore, there remains a need for a new and improved design for an intelligent tungsten carbide cutter to overcome the problems presented above.

### SUMMARY OF THE INVENTION

The present invention provides an intelligent tungsten carbide cutter which comprises a shank, at least a cutting portion, and a sensor. The shank made of tungsten steel comprises a first end, a second end, and at least a first connecting portion, and the first connecting portion is located adjacent to the second end of the shank. The shank and the cutting portion are thermally connected through high frequency oscillation heating method, and the cutting portion is secured on the first connecting portion of the shank. An accommodating channel axially penetrates through a center portion of the first end of the shank and extends toward the second end, and the sensor is installed in the accommodating channel so as to be positioned close to the cutting portion, thereby achieving the direct and accurate sensing. The cutting portion made of tungsten steel has a cutting edge and a second connecting portion, and the second connecting portion is coupled and thermally connected with the first connecting portion through high frequency oscillation heating method, such that the cutting portion is secured on the first connecting portion of the shank for cutting purpose. The sensor is installed in the accommodating channel of the shank to achieve real-time sensing when the cutting portion is used, such that the sensor is adapted to timely detect abnormal status of the cutting portion, so as to warn an operator through a display of a processor or wirelessly sent status information to a mobile device of the operator, and the operator is configured to fully grasp the status of the intelligent tungsten carbide cutter and determine whether the replacement or calibration is needed.

Comparing with conventional tungsten carbide cutter, the present invention is advantageous because: (i) the cutting portion is thermally connected to the shank through high frequency heating method, which makes the cutting portion more easier to be replaced, such that the shank can be recycled individually and the replacement process of the cutting portion is more cost-saving; (ii) the recycled shank can be re-connected to another cutting portion, which significantly reduces operating costs; (iii) the sensor can detect abnormal conditions of the cutting portion and timely warn the operator during operation, which improves the processing quality; and (iv) the sensor is installed in the accommodating channel of the shank and is adapted to achieve the detecting process and signal reading through wireless method, which will not affect the function of cutting portion and allows the installation process of the sensor simple and rapid.

### BRIEF DESCRIPTION OF THE DRAWINGS

FIG. 1 is a three-dimensional assembly view of a first embodiment of an intelligent tungsten carbide cutter in the present invention.

FIG. 2 is a three-dimensional exploded view of the first embodiment of the intelligent tungsten carbide cutter in the present invention.

FIG. 3 is a schematic view illustrating the thermal connection between a shank and a cutting portion of the intelligent tungsten carbide cutter through high frequency oscillation heating method.

FIG. 4 is a sectional partial enlarged diagram illustrating the connection between the shank and the cutting portion of the intelligent tungsten carbide cutter after processed through high frequency oscillation heating method.

FIG. 5 is a block diagram of a sensor of the intelligent tungsten carbide cutter in the present invention.

FIG. 6 is a block diagram illustrating the two-way information transmission status of the intelligent tungsten carbide cutter when detecting abnormal status of the cutting portion.

FIG. 7 is a schematic view illustrating the sensor is real-time functional when the intelligent tungsten carbide cutter is used.

FIG. 8 is a schematic view illustrating the sensor detects abnormal status and sends the informational to a processor or a mobile device through a signal transmission.

FIG. 9 is a three-dimensional assembly view of a second embodiment of the intelligent tungsten carbide cutter in the present invention.

FIG. 10 is a three-dimensional exploded view of the second embodiment of the intelligent tungsten carbide cutter in the present invention.

FIG. 11 is a three-dimensional assembly view of a third embodiment of the intelligent tungsten carbide cutter in the present invention.

FIG. 12 is a three-dimensional exploded view of the third embodiment of the intelligent tungsten carbide cutter in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

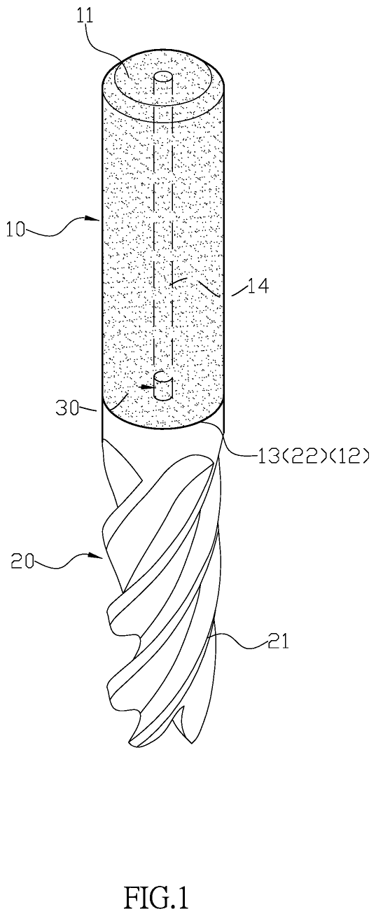

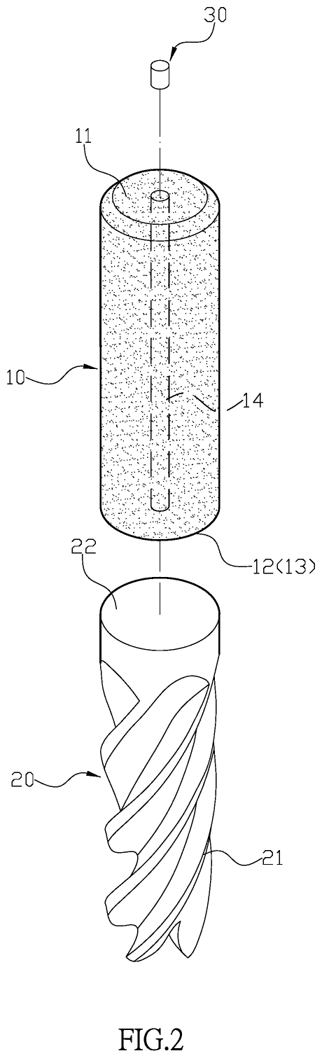

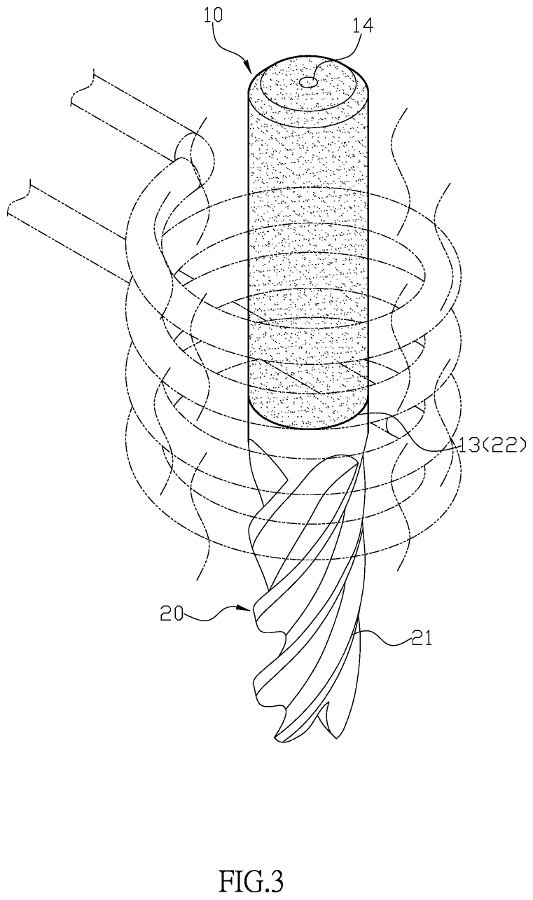

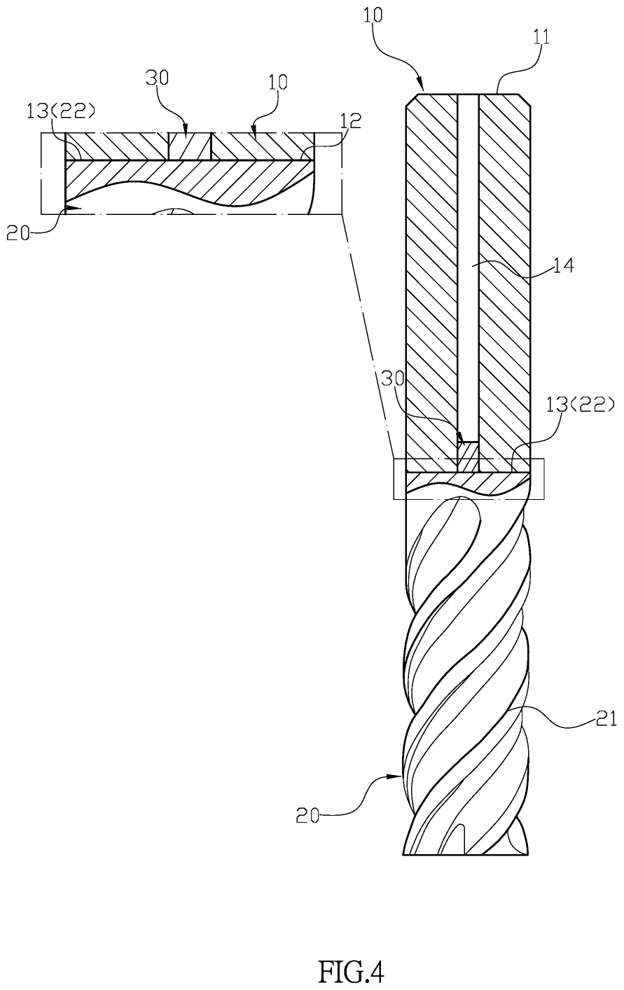

Referring to FIGS. 1 to 4, the present invention provides an intelligent tungsten carbide cutter which comprises a shank (10), at least a cutting portion (20), and a sensor (30). The shank (10) made of tungsten steel comprises a first end (11), a second end (12), and at least a first connecting portion (13), and the first connecting portion (13) is located adjacent to the second end (12) of the shank (10). The shank (10) and the cutting portion (20) are thermally connected through high frequency oscillation heating method, and the cutting portion (20) is secured on the first connecting portion (13) of the shank (10). An accommodating channel (14) axially penetrates through a center portion of the first end (11) of the shank (10) and extends toward the second end (12), and the sensor (30) is installed in the accommodating channel (14) so as to be positioned close to the cutting portion (20), thereby achieving more direct and accurate sensing. The cutting portion (20) made of tungsten steel has a cutting edge (21) and a second connecting portion (22), and the second connecting portion (22) is coupled and thermally connected with the first connecting portion (13) through high frequency oscillation heating method, such that the cutting portion (20) is secured on the first connecting portion (13) of the shank (10) for cutting purpose. The sensor (30) is installed in the accommodating channel (14) of the shank (10) to achieve real-time sensing when the cutting portion (20) is used, such that the sensor (30) is adapted to timely detect abnormal status of the cutting portion (20), so as to warn an operator through a display (51) of a processor (50) such as a computer numerical control (CNC) or wirelessly sent status information to a mobile device (60) of the operator, and the operator is configured to fully grasp the status of the intelligent tungsten carbide cutter and determine whether the replacement or calibration is needed.

In one embodiment, the accommodating channel (14) axially penetrates through the center portion of the first end (11) of the shank (10) toward the second end (12), and axially penetrates through the second end (12) of the shank (10) (as shown in FIGS. 1 to 4, and 6 to 8).

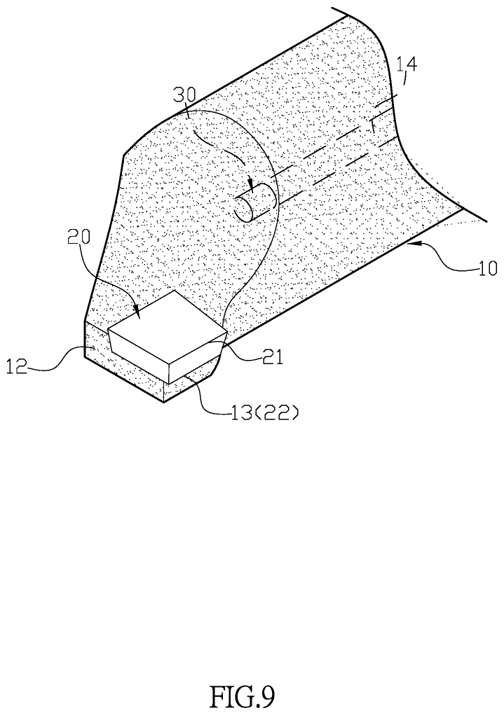

In another embodiment, the accommodating channel (14) axially penetrates through the center portion of the first end (11) of the shank (10) toward the second end (12), and not penetrates through the second end (12) of the shank (10) (as shown in FIGS. 9 to 12).

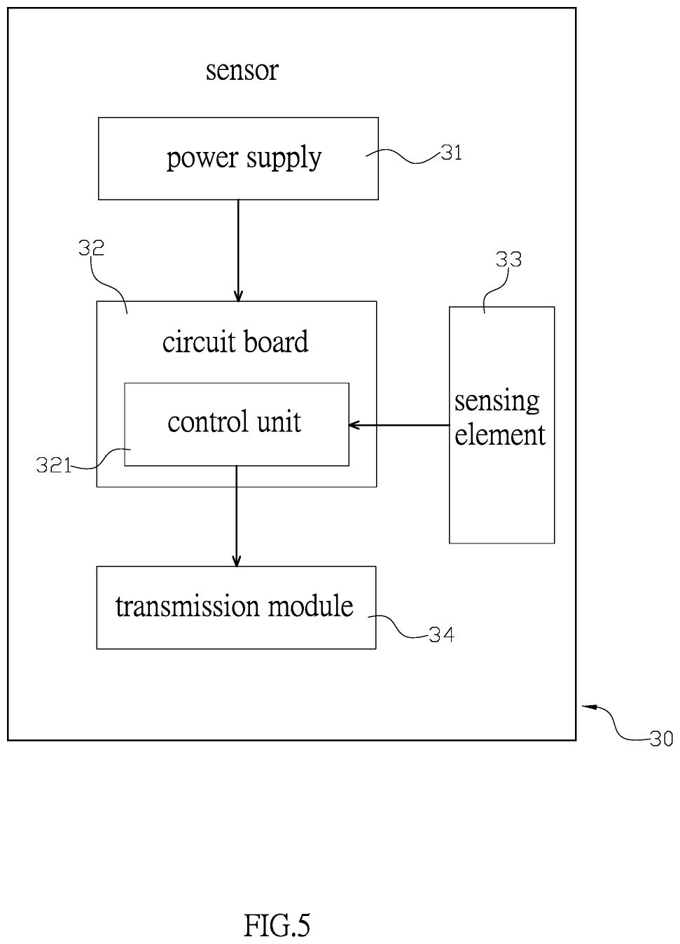

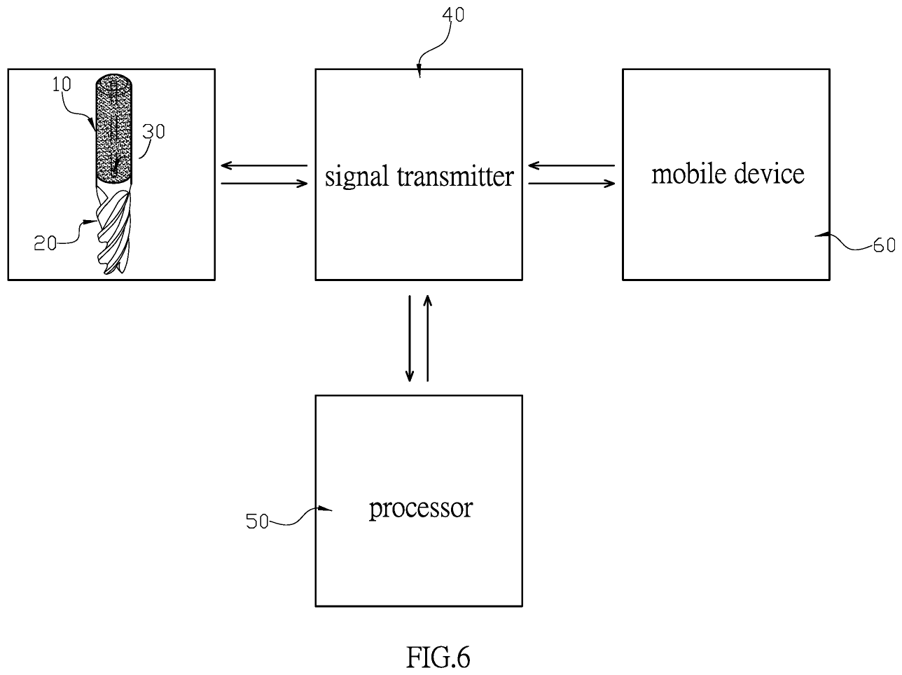

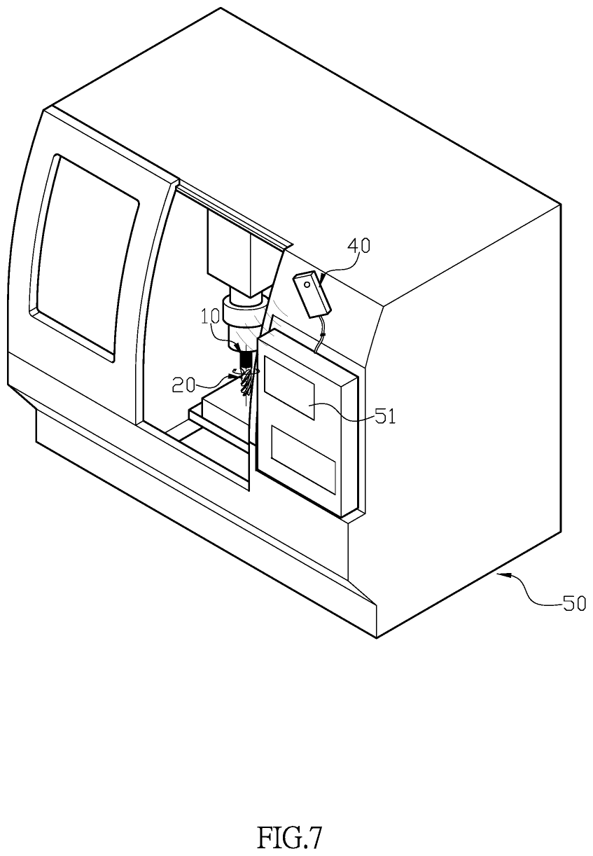

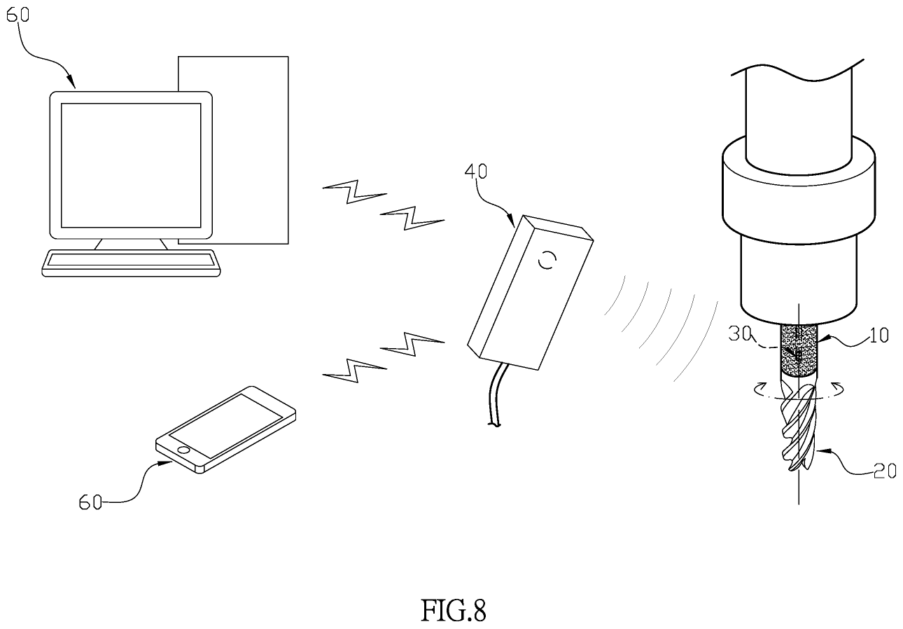

In still another embodiment, the sensor (30) comprises a power supply (31), a circuit board (32), a sensing element (33), and a transmission module (34) (as shown in FIG. 5); wherein the power supply (31) is adapted to provide power to all components of the sensor (30), and the circuit board (32) electrically connected to the power supply (31) comprises a control unit (321) to control the overall operation of the sensor (30); wherein the sensing element (33) is electrically connected to the circuit board (32) to detect abnormal status of the cutting edge (21) of the cutting portion (20) such as abnormal temperature, abnormal vibration, and abnormal sound during cutting process and to send the detected abnormal information to the control unit (321) of the circuit board (32); the transmission module (34) is coupled to the control unit (321) of the circuit board (32) to receive the information transmitted from the control unit (321), and then to provide a signal to a signal transmitter (40) for reading, and the information is adapted to be displayed on the display (51) of the processor (50) (as shown in FIGS. 6 and 7) or to be sent wirelessly through the signal transmitter (40) to the mobile device (60) of the operator (as shown in FIG. 8). The mobile device (60) can be a smart phone, a tablet, a laptop, a desktop or a PDA. The processor (50) or the mobile device (60) is adapted to make feedback to reset the sensor (30) after receiving the abnormal warning, and automatically turn off the warning message on the processor (50) or the mobile device (60) to avoid the misjudgment of the operator.

In a further embodiment, the first connecting portion (13) is directly connected to the second end (12) of the shank (10) to enable the intelligent tungsten carbide cutter to be used as a milling cutter (as shown in FIGS. 1 to 4 and 6 to 8).

In still a further embodiment, the first connecting portion (13) is directly connected to the second end (12) of the shank (10) to enable the intelligent tungsten carbide cutter to be used as a drill bit.

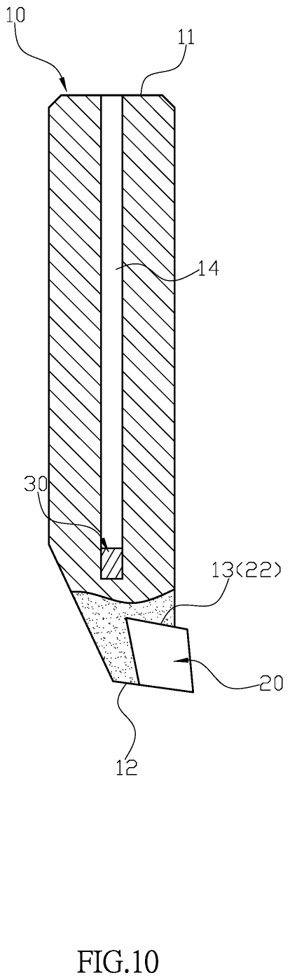

In yet a further embodiment, the first connecting portion (13) is formed adjacent to the second end (12) of the shank (10) to enable the intelligent tungsten carbide cutter to be used as a tool bit (as shown in FIGS. 9 and 10).

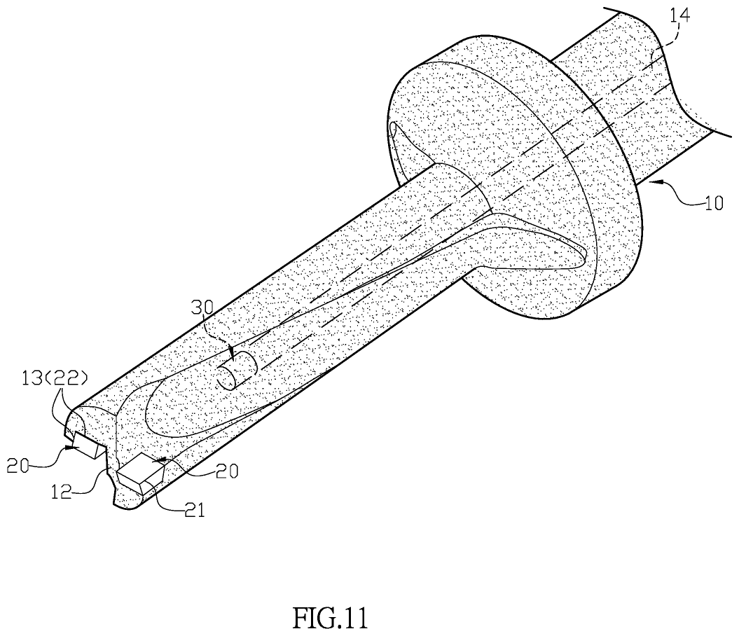

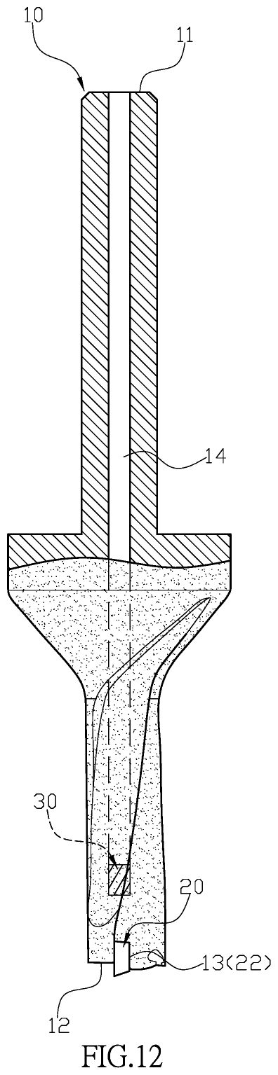

In a preferred embodiment, the shank (10) comprises a plurality of first connecting portions (13) which are evenly arranged on an outer periphery of the shank (10) adjacent to the second end (12) thereof, and each of the first connecting portions (13) is connected to one cutting portion (20) to enable the intelligent tungsten carbide cutter to be used as a rapid drill (as shown in FIGS. 11 and 12).

In another preferred embodiment, the diameter of the accommodating channel (14) is 3 mm.

In an advantageous embodiment, the shank (10) and the cutting portion (20) are thermally connected through high frequency welding.

In a particular embodiment, the shank (10) and the cutting portion (20) are thermally connected through high frequency fusion welding.

In actual application, the shank (10) is held by an operator, and either the cutting portion (20) or the object to be cut is rotated, so that the cutting edge (21) of the cutting portion (20) can cut on the surface of the object. When the cutting portion (20) is worn, damaged, not fully calibrated or has abnormal conditions such as abnormal temperature, abnormal vibration, and abnormal sound of the cutting edge (21) of the cutting portion (20) during cutting process, the sensor (30) is adapted to timely detect the abnormal status and warn the operator, such that the operator can repair or do maintenance immediately according to warning information so as to properly replace the cutting portion (20).

Comparing with conventional tungsten carbide cutter, the present invention is advantageous because: (i) the cutting portion (20) is thermally connected to the shank (10) through high frequency heating method, which makes the cutting portion (20) more easier to be replaced, such that the shank (10) can be recycled individually and the replacement process of the cutting portion (20) is more cost-saving; (ii) the recycled shank (10) can be re-connected to another cutting portion (20), which significantly reduces operating costs; (iii) the sensor (30) can detect abnormal conditions of the cutting portion (20) and timely warn the operator during operation, which improves the processing quality; and (iv) the sensor (30) is installed in the accommodating channel (14) of the shank (10) and is adapted to achieve the detecting process and signal reading through wireless method, which will not affect the function of cutting portion (20) and allows the installation process of the sensor (30) simple and rapid.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An intelligent tungsten carbide cutter comprising a shank, at least a cutting portion, and a sensor;
wherein the shank made of tungsten steel comprises a first end, a second end, and at least a first connecting portion, and the first connecting portion is located adjacent to the second end of the shank; the shank and the cutting portion are thermally connected through high frequency oscillation heating method, and the cutting portion is secured on the first connecting portion of the shank; an accommodating channel axially penetrates through a center portion of the first end of the shank and extends toward the second end, and the sensor is installed in the accommodating channel so as to be positioned close to the cutting portion, thereby achieving the direct and accurate sensing;
wherein the cutting portion made of tungsten steel has a cutting edge and a second connecting portion, and the second connecting portion is coupled and thermally connected with the first connecting portion through high frequency oscillation heating method, such that the cutting portion is secured on the first connecting portion of the shank for cutting purpose; and
wherein the sensor is installed in the accommodating channel of the shank to achieve real-time sensing when the cutting portion is used, such that the sensor is adapted to timely detect abnormal status of the cutting portion, so as to warn an operator through a display of a processor or wirelessly sent status information to a mobile device of the operator, and the operator is configured to fully grasp the status of the intelligent tungsten carbide cutter and determine whether the replacement or calibration is needed.

2. The intelligent tungsten carbide cutter of claim 1, wherein the sensor comprises a power supply, a circuit board, a sensing element, and a transmission module; wherein the power supply is adapted to provide power to all components of the sensor, and the circuit board electrically connected to the power supply comprises a control unit to control the overall operation of the sensor; wherein the sensing element is electrically connected to the circuit board to detect abnormal status of the cutting edge of the cutting portion such as abnormal temperature, abnormal vibration, and abnormal sound during cutting process and to send the detected abnormal information to the control unit of the circuit board; the transmission module is coupled to the control unit of the circuit board to receive the information transmitted from the control unit, and to provide a signal to a signal transmitter for reading, and the information is adapted to be displayed on the display of the processor or to be sent wirelessly through the signal transmitter to the mobile device of the operator.

3. The intelligent tungsten carbide cutter of claim 2, wherein the mobile device is a smart phone, a tablet, a laptop, a desktop or a PDA.

4. The intelligent tungsten carbide cutter of claim 2, wherein the processor or the mobile device is adapted to make feedback to reset the sensor after receiving the abnormal warning, and automatically turn off the warning message on the processor or the mobile device to avoid the misjudgment of the operator.

5. The intelligent tungsten carbide cutter of claim 1, wherein the accommodating channel axially penetrates through the center portion of the first end of the shank toward the second end, and axially penetrates through the second end of the shank.

6. The intelligent tungsten carbide cutter of claim 1, wherein the accommodating channel axially penetrates through the center portion of the first end of the shank toward the second end, and not penetrates through the second end of the shank.

7. The intelligent tungsten carbide cutter of claim 1, wherein the first connecting portion is directly connected to the second end of the shank to enable the intelligent tungsten carbide cutter to be used as a milling cutter.

8. The intelligent tungsten carbide cutter of claim 1, wherein the first connecting portion is directly connected to the second end of the shank to enable the intelligent tungsten carbide cutter to be used as a drill bit.

9. The intelligent tungsten carbide cutter of claim 1, wherein the first connecting portion is formed adjacent to the second end of the shank to enable the intelligent tungsten carbide cutter to be used as a tool bit.

10. The intelligent tungsten carbide cutter of claim 1, wherein the shank comprises a plurality of first connecting portions which are evenly arranged on an outer periphery of the shank adjacent to the second end thereof, and each of the first connecting portions is connected to one cutting portion to enable the intelligent tungsten carbide cutter to be used as a rapid drill.

11. The intelligent tungsten carbide cutter of claim 1, wherein the shank and the cutting portion are thermally connected through high frequency welding.

12. The intelligent tungsten carbide cutter of claim 1, wherein the shank and the cutting portion are thermally connected through high frequency fusion welding.
